(19) United States
(12) Patent Application Publication
(10) Pub. No.: US 2026/0243608 A1
(43) Pub. Date: Aug. 20, 2026

(54) ESTIMATION METHOD AND APPARATUS FOR GROUND SURFACE THERMAL STATE DISTRIBUTION AT REGULAR GRID IN PERMAFROST REGION

(71) Applicant: Northwest Institute of Eco-Environment and Resources Chinese Academy of Sciences, Lanzhou City (CN)

(72) Inventors: Dongliang Luo, Lanzhou City (CN); Fangfang Chen, Lanzhou City (CN); Jia Liu, Lanzhou City (CN); Shizhen Li, Lanzhou City (CN); Yajuan Zao, Lanzhou City (CN)

(73) Assignee: Northwest Institute of Eco-Environment and Resources Chinese Academy of Sciences, Lanzhou City (CN)

(21) Appl. No.: 19/337,755

(22) Filed: Sep. 23, 2025

(30) Foreign Application Priority Data
Feb. 17, 2025 (CN) 202510171574.3

(51) Int. Cl. G01K 3/14

(52) U.S. Cl. CPC G01K 3/14; G01K 2213/00

(57) ABSTRACT

The present disclosure provides an estimation method and an apparatus for ground surface thermal state distribution at regular grid in permafrost region. In the method, the electronic device obtains the measured temperature information and predicted temperature information of a target permafrost region, wherein the measured temperature information includes measured ground surface temperatures at multiple observation scales, and the predicted temperature information includes predicted ground surface temperatures at multiple observation scales; corrects the predicted temperature information by a pre-constructed semi-variational function model to obtain optimized predicted temperature information; combines the optimized predicted temperature information with the measured temperature information to obtain ground surface temperature information of the target permafrost region; and generates a ground surface thermal state distribution map of the target permafrost region based on the ground surface temperature information of the target permafrost region.

### CROSS-REFERENCE TO RELATED APPLICATIONS

The present disclosure claims the priority to the Chinese patent application No. 202510171574.3, filed with the Chinese Patent Office on Feb. 17, 2025, and entitled “ESTIMATION METHOD AND APPARATUS FOR GROUND SURFACE THERMAL STATE DISTRIBUTION AT REGULAR GRID IN PERMAFROST REGION”, the contents of which are incorporated herein by reference in their entirety.

### TECHNICAL FIELD

The present disclosure relates to the technical field of physical geography and geographic information systems, and more specifically, to an estimation method and an apparatus for ground surface thermal state distribution at regular grid in permafrost region.

### BACKGROUND ART

Permafrost, a critical component of the cryosphere, significantly influences the Earth's climate system through its interactions with the atmosphere, biosphere, hydrosphere, and pedosphere. The permafrost, seasonally frozen ground, and ephemeral frozen ground constitutes approximately 50% of the exposed land surface area, with permafrost alone accounts for about 22% of the land surface area of the Northern Hemisphere. The soil organic carbon stored within permafrost is greater than the combined total of vegetation and atmospheric carbon pools, making it one of the most critical carbon pools in terrestrial ecosystems. Consequently, even minor changes in permafrost can affect the atmosphere and exert profound impacts on sustainable economic development and the achievements of carbon neutrality goals. To assess the influence of permafrost change on the ecosystems, natural resources, and engineering infrastructures, it is essential to accurately model or simulate the thermal state of permafrost.

However, traditional methods for investigating the thermal state of permafrost, which often involve drilling, suffer from a lack of essential data, cause ecological damage, and are subject to the scale effect of monitoring systems. For example, the process of moving drilling rigs and initiating drilling can cause considerable damage to surrounding vegetation and soil, which is particularly difficult to restore in high-altitude permafrost regions with harsh climates. Such activities can even lead to ecological degradation, exacerbating issues like land desertification. Furthermore, monitoring the thermal state of permafrost, whether through drilling or self-recording thermometers, presents a challenge related to the scale effect of the monitoring system, specifically in determining the optimal distance between adjacent monitoring points. If the distance is too large, the spatial differentiation of geographical factors can lead to insufficient data coverage. Conversely, if the distance is too small, the strong spatial autocorrelation results in redundant data, significantly increasing monitoring costs.

Ground surface temperature is not only a key indicator of energy and moisture exchange between the atmosphere and the soil, but also a crucial upper thermal boundary condition for permafrost simulation and mapping. It plays a decisive role in regulating cryosphere-related processes and their interactions with climate change and eco-hydrology. Therefore, a need exists for a method to nondestructively acquire the thermal state of permafrost to guide engineering practices and ecological assessments while addressing the problem of monitoring scale.

### SUMMARY

To address at least one of the deficiencies in the prior art, the present disclosure provides an estimation method and an apparatus for the ground surface thermal state distribution at regular grid in permafrost region, including the following.

In a first aspect, the present disclosure provides an estimation method for the ground surface thermal state distribution at regular grid in permafrost region, wherein the method includes:
obtaining measured temperature information and predicted temperature information of a target permafrost region, wherein the measured temperature information includes measured ground surface temperatures at multiple observation scales, and the predicted temperature information includes predicted ground surface temperatures at multiple observation scales;
correcting the predicted temperature information using a pre-constructed semi-variational function model to obtain optimized predicted temperature information, wherein the semi-variational function model characterizes the spatial variability of ground surface temperatures in the target permafrost region;
combining the optimized predicted temperature information with the measured temperature information to obtain ground surface temperature information of the target permafrost region; and
generating a ground surface thermal state distribution map of the target permafrost region based on the ground surface temperature information of the target permafrost region.

In a second aspect, an estimation apparatus for the ground surface thermal state distribution at regular grid in permafrost region is provided in the present disclosure, wherein the apparatus includes:
a temperature acquisition module configured to obtain measured temperature information and predicted temperature information of a target permafrost region, wherein the measured temperature information includes measured ground surface temperatures at multiple observation scales, and the predicted temperature information includes predicted ground surface temperatures at multiple observation scales;
a temperature optimization module, configured to correct the predicted temperature information by a pre-constructed semi-variational function model to obtain optimized predicted temperature information, wherein the semi-variational function model characterizes a measurement error of the ground surface temperature, a spatial variability, and a maximum distance of a spatial autocorrelation in the target permafrost region;
the temperature optimization module, further configured to combine the optimized predicted temperature information with the measured temperature information to obtain ground surface temperature information of the target permafrost region; and
a map drawing module, configured to generate a ground surface thermal state distribution map of the target permafrost region based on the ground surface temperature information of the target permafrost region.

In a third aspect, the present disclosure provides a non-transitory computer-readable storage medium, wherein the storage medium stores computer programs, and the estimation method for ground surface thermal state distribution at regular grid in permafrost region is realized when the computer programs are executed by a processor.

In a fourth aspect, the present disclosure provides an electronic device, wherein the electronic device includes a processor and a memory; the memory stores computer programs; and the estimation method for ground surface thermal state distribution at regular grid in permafrost region is realized when the computer programs are executed by the processor.

Compared to the prior art, the present disclosure includes the following beneficial effects.

The present disclosure provides an estimation method and an apparatus for ground surface thermal state distribution at regular grid in permafrost region. In the method, the electronic device obtains the measured temperature information and predicted temperature information of a target permafrost region, wherein the measured temperature information includes measured ground surface temperatures at multiple observation scales, and the predicted temperature information includes predicted ground surface temperatures at multiple observation scales; the electronic device corrects the predicted temperature information by a pre-constructed semi-variational function model to obtain optimized predicted temperature information, wherein the semi-variational function model characterizes a measurement error of the ground surface temperature, spatial variability, and spatial autocorrelation in the target permafrost region; the electronic device combines the optimized predicted temperature information with the measured temperature information to obtain ground surface temperature information of the target permafrost region; and the electronic device generates a ground surface thermal state distribution map of the target permafrost region based on the ground surface temperature information of the target permafrost region. In this way, by utilizing the predicted ground surface temperatures and measured ground surface temperatures at different scales, the thermal state of permafrost can be non-destructively obtained, and the ground surface thermal state distribution map at the reasonable setting monitoring spatial scales is generated. This effectively guides the engineering construction practice and ecological environment assessment of the permafrost region.

### BRIEF DESCRIPTION OF DRAWINGS

In order to more clearly illustrate the technical solutions in the embodiments of the present disclosure, the drawings to be used in the embodiments will be briefly introduced below. It is to be understood that the following drawings only show certain embodiments of the present disclosure, and therefore should not be regarded as a limitation of the scope. For persons of ordinary skill in the field, other relevant drawings can be obtained according to these drawings without inventive efforts.

FIG. 1 shows a schematic flow diagram of an estimation method for ground surface thermal state distribution at regular grid in permafrost region provided by the embodiments of the present disclosure;

FIG. 2 shows a schematic diagram of temperature distribution layers of a permafrost region provided by the embodiments of the present disclosure;

FIG. 3 shows a schematic diagram of a relationship between multi-stage temperature sensor arrays provided by the embodiments of the present disclosure;

FIG. 4 shows a structure schematic diagram of an estimation apparatus for ground surface thermal state distribution at regular grid in permafrost region provided by the embodiments of the present disclosure; and

FIG. 5 shows a structure schematic diagram of an electronic device provided by the embodiments of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely in the following in conjunction with the accompanying drawings in the embodiments of the present disclosure. It is clear that the embodiments described are partial embodiments of the present disclosure, but not all of the embodiments. The components in the embodiments of the present disclosure generally described and shown in the drawings herein can be arranged and designed in multiple different configurations.

Therefore, the following detailed description of embodiments of the present disclosure provided in the drawings is not intended to limit the scope of the present disclosure for which protection is claimed, but rather represents only selected embodiments of the present disclosure. Based on the embodiments of the present disclosure, all other embodiments obtained by a person of ordinary skill in the art without inventive efforts, shall fall within the scope of protection of the present disclosure.

It should be noted that similar symbols and letters represent similar items in the following drawings, so that once an item is defined in a drawing, no further definition or explanation is required in the subsequent drawings.

In the description of the present disclosure, it should be noted that in addition, the terms “first”, “second”, “third”, etc., are used only to differentiate the description, and are not to be understood as indicating or implying relative importance. Furthermore, the terms “include”, “comprise”, or any other variant thereof are intended to cover a non-exclusive inclusion, so that a process, method, item, or device comprising a set of components includes not only those components, but also other component that are not explicitly listed, or component are inherent to this process, method, item, or device. In the absence of further limitations, an element defined by the phrase “comprising one . . . ” does not exclude the presence of additional identical elements in a process, method, article, or device that comprises the element.

Based on the above statement, as described in the background art, the traditional permafrost engineering and the permafrost drilling for temperature detection have problems of the ecological damage and the scale effect of the monitoring system.

In this regard, it should be understood that in the related techniques, the geological exploration mainly relies on drilling and temperature chain measurement to obtain the thermal state of the permafrost. However, during the process of drilling rig entry and drilling initiation, considerable damage will be caused to the surrounding vegetation and soil, especially in the high-altitude permafrost region with harsh climatic conditions, and these damages are difficult to restore. Permafrost drilling may even lead to ecological degradation, aggravating problems such as black soil beach formation, land desertification, and desertification of alpine grasslands. Therefore, how to nondestructively obtain the thermal state of permafrost for guiding permafrost engineering construction practice and permafrost ecological environment assessment has become one of the major problems urgently to be solved in the field of geo-engineering and environmental science and technology.

In addition, when conducting the ecological assessment, freeze-thaw disaster prediction, and permafrost engineering design and construction operation, whether using the permafrost drilling or the self-recording thermometer to monitor the thermal state of permafrost, there will be a problem of scale effect in the monitoring system, that is, how to set the distance between adjacent monitoring points. If the distance between adjacent monitoring points is too large, due to the spatial differentiation characteristics of geographical factors, there will inevitably be a condition of insufficient data coverage. Conversely, if the distance between adjacent monitoring points is too small, the spatial autocorrelation is stronger, which will lead to a significant increase in monitoring costs and consume more human and financial resources. Therefore, how to reasonably set the monitoring spatial scale of the permafrost factors has become a problem to be emphasized in the fields of physical geography and geographic information system at present.

Based on the discovery of the above technical issue, the inventors, through inventive efforts, provide the following technical solutions to address or partially address the above problems. It should be noted that the defects existing in the above prior art solutions are results derived by the inventors after practical experience and careful research. Therefore, in the following text, the discovery process of the above problems and the solutions provided in the embodiments of the present disclosure in regarding to the above problems should all be regarded as the contributions made by the inventor during the invention process, and should not be understood as the common technical content known to those skilled in the field.

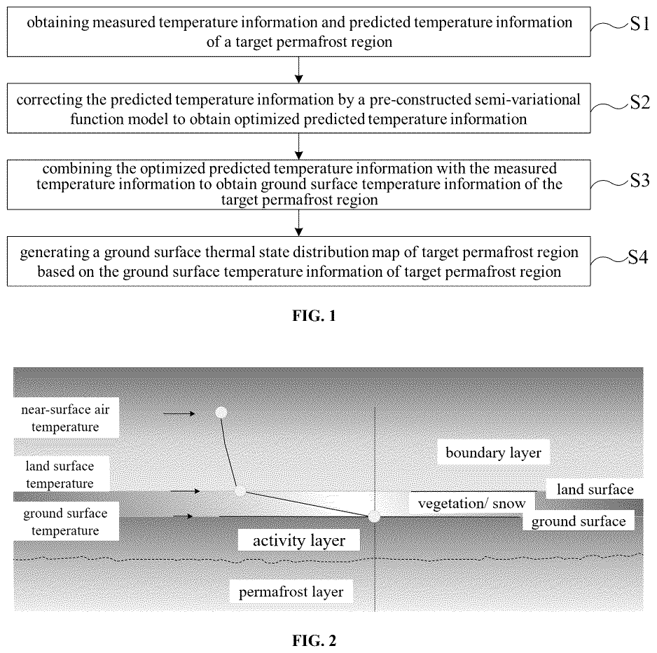

In view of this, the embodiments of the present disclosure (hereinafter referred to as the embodiments) provide an estimation method for ground surface thermal state distribution at regular grid in permafrost region. As shown in FIG. 1, the method includes:
S1, obtaining measured temperature information and predicted temperature information of a target permafrost region, wherein
the measured temperature information includes measured ground surface temperatures at multiple observation scales, and the predicted temperature information includes predicted ground surface temperatures at multiple observation scales;
S2, correcting the predicted temperature information by a pre-constructed semi-variational function model to obtain optimized predicted temperature information, wherein
the semi-variational function model characterizes a measurement error of the ground surface temperature, spatial variability, and a distance of spatial autocorrelation in the target permafrost region;
S3, combining the optimized predicted temperature information with the measured temperature information to obtain ground surface temperature information of the target permafrost region; and
S4, generating a ground surface thermal state distribution map of the target permafrost region based on the ground surface temperature information of the target permafrost region.

In this way, by utilizing the predicted ground surface temperatures and measured ground surface temperatures at different scales, the thermal state of permafrost can be non-destructively obtained, and the ground surface thermal state distribution map at the reasonable setting monitoring spatial scales is generated, thus effectively guiding the engineering construction practice and ecological environment assessment.

For the estimation method for ground surface thermal state distribution at regular grid in permafrost region, which is provided in the embodiment, an electronic device for implementing the method can be, but is not limited to, a mobile terminal, a tablet computer, a laptop computer, a desktop computer, and a server, etc. This server can be a single server or a server group. The server group can be centralized or distributed (for example, the servers can be a distributed system). In some embodiments, the server can be local or remote relative to the user terminal. In some embodiments, the server can be implemented on a cloud platform. As an example only, the cloud platform can include private cloud, public cloud, hybrid cloud, community cloud, distributed cloud, inter-cloud, a multi-cloud, or any combination thereof. In some embodiments, the server can be implemented on an electronic device with one or more components.

In order to make the solutions provided by the embodiment clearer, each step in FIG. 1 is described in detail below by taking a server as an electronic device for implementing the method. However, it should be understood that the operations of the flow diagram do not have to be performed in order, and steps without logical context can be reversed in order or implemented simultaneously. Additionally, a person skilled in the art, under the guidance of the present disclosure, can add one or more other operations to the flow diagram, or can remove one or more operations from the flow diagram. Accordingly, continuing to refer to FIG. 1, the method includes:

S1, obtaining measured temperature information and predicted temperature information of the target permafrost region.

The measured temperature information includes measured ground surface temperatures at multiple observation scales, and the predicted temperature information includes predicted ground surface temperatures at multiple observation scales.

The target permafrost region in the embodiment refers to the region where the thermal state of the ground surface is unknown. Firstly, it generates the predicted temperature information at multiple types of observation scales based on the vegetation information, soil information, climate information, and topographic information by using a pre-trained temperature prediction model. However, since the prediction model may have certain errors, it needs to be corrected by using measured temperature information obtained from the multi-stage temperature sensor array. Thus, as an optional embodiment, the step S1 can include:
S1-1, obtaining the vegetation information, soil information, climate information, and topographic information of the target permafrost region; and
S1-2, processing the vegetation information, soil information, climate information, and topographic information by a pre-trained temperature prediction model, so as to obtain predicted temperature information of the target permafrost region.

The training method of the above temperature prediction model is described below. In order to train a temperature prediction model, several stages are required, including data acquisition, data preprocessing, feature extraction and dimension reduction, and model training, so as to ensure that the model can accurately predict the ground surface temperature of the permafrost region.

Before illustrating the above-mentioned training method for the temperature prediction model, firstly, it is necessary to note that the ground surface temperature in the embodiment refers to the temperature at a specific depth position. As shown in FIG. 2, the temperature distribution layers of the permafrost region includes a boundary layer, land surface, ground surface, active layer, and permafrost layer. The detection position of ground surface temperature is located at 0-10 cm depth of the vegetation root system, and observations of the near-surface air temperature and land surface temperature are deployed based on differences in altitude and terrain. However, methods based on the calculation of land surface temperature (LST) from MODIS thermal infrared data or utilizing such LST to drive permafrost simulation and mapping can only detect the thermal infrared land surface temperature of vegetation or snow canopies. These studies do not consider the complex thermal effect of the vegetation or snow, and there is an essential difference between the thermal infrared land surface temperature and the ground surface temperature. The ground surface temperature in the embodiment is the temperature at a 0-10 cm depth within the vegetation root system, which is the true upper thermal boundary condition of empirical or physical process-based permafrost simulation mapping.

In addition, the above multiple observation scales show a pattern of progressive transition. Therefore, the training samples also need to be collected at multiple observation scales, so as to facilitate the revelation of the scale effect of the ground surface temperature. In this regard, a multi-stage temperature sensor array is deployed in the target permafrost region, the lower-stage array in the multi-stage temperature sensor array is distributed in grid of the upper-stage array, and the lower-stage array and the upper-stage array include the same number of temperature sensors and have the same distribution pattern.

In this way, the data acquisition at different observation scales is realized by deploying the multi-stage temperature sensor array within the target permafrost region. These sensor arrays are distributed in a certain pattern to ensure that data acquisition at each scale can complement and support each other. For example, the upper-stage array may cover a wider area, and the lower-stage array performs finer measurements inside the grid of the upper-stage array. Thus, the hierarchical deployment method of sensor can not only improve the data richness and accuracy, but also help to identify the temperature variation pattern and abnormal conditions, the temperature measurement value error, and the distance of spatial autocorrelation at different scales.

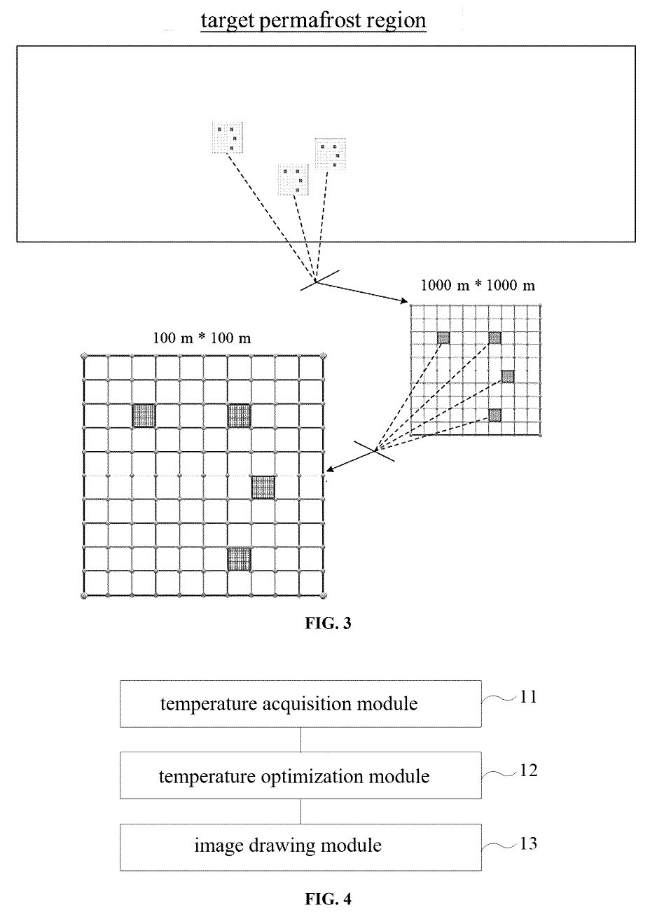

(1) During the data acquisition stage, in order to better reveal the scale effect of the ground surface temperature, regular grids are deployed in the target permafrost region for monitoring. As shown in FIG. 3, for the target permafrost region, a progressive multi-scale regular grid is used for the sensor deployment. That is, three different scales of grid units of 10 m×10 m, 100 m×100 m, and 1000 m×1000 m are arranged in the study area, and the temperature sensors are uniformly distributed inside each grid unit. The small-scale (10 m×10 m) grid is used to capture micro-environmental changes and is suitable for studying the thermal state characteristics of local permafrost; the medium-scale (100 m×100 m) grid is used to perform long-term trend analyses and is suitable for monitoring the thermal state of medium-scale permafrost region; and the large-scale (1000 m×1000 m) grid is used to estimate the regional-level spatial distribution and provides data support for large-scale permafrost modeling and massive remote sensing products.

Further, within each regular grid unit, the arrangement of sensors follows the principle of hierarchical nesting. That is, the sensors of the lower grid are distributed in the sub-units of the upper grid, and they maintain the same number and distribution pattern. For example, within a 100 m×100 m grid, it selects some 10 m×10 m sub-grids to evenly arrange temperature sensors inside, so as to ensure the comparability and consistency of the multi-scale data. This nested sensor deployment not only improves the spatial resolution of the data, but also improves the prediction accuracy through combining data at different scales.

In addition, since the near-surface air temperature is less affected by turbulence and surface canopies, only 1 or 2 observations of near-surface air temperature and land surface temperature are arranged for each 100 m×100 m and 1000 m×1000 m area, and additional observations of near-surface air temperature and land surface temperature are considered only when the terrain has larger undulations (with an altitude difference of more than 50 m).

Meanwhile, various data acquisition methods, such as remote sensing imagery, ground observation, unmanned aerial vehicle mapping, weather station monitoring, and historical data acquisition are utilized to obtain the vegetation information, soil information, climate information, and topographic information of each grid node (also known as observation point). A detailed description of how this information is obtained is provided below.

The vegetation information is mainly obtained through ground quadrat survey, satellite remote sensing imagery, and unmanned aerial vehicle multispectral mapping. Vegetation indices (such as NDVI, EVI) are calculated by using satellite remote sensing data such as Landsat, MODIS, so as to assess the vegetation coverage and health condition. In addition, high-resolution vegetation indices are obtained by unmanned aerial vehicle hyperspectral imaging, and combined with ground quadrat survey to measure information such as vegetation height and above-ground biomass, so that the effect of vegetation on the ground surface temperature is refined.

Soil information is obtained in conjunction with ground sampling, laboratory analysis, and remote sensing inversion. The ground survey uses the root drilling sampling methods to measure key parameters such as soil texture, soil water content, soil organic matter content, and dry bulk weight. Laboratory analysis further determines thermophysical properties of the soil, such as thermal conductivity and thermal diffusivity in thawed and frozen states. In addition, the soil moisture information is extracted by using thermal infrared remote sensing and microwave remote sensing, and the spatial interpolation is performed by geostatistical analysis, so as to compensate for the limitations of observation points.

The climate information can be acquired through the data collection from ground weather station monitoring, long-term meteorological data, and reanalysis data. Specifically, the automatic weather station can be deployed in the study area to monitor key meteorological parameters, such as air temperature, precipitation, wind speed and direction, and relative humidity in real time. Meanwhile, the global meteorological reanalysis data, such as ERA5-Land and GLDAS, are collected to provide long-term climate background information, and are combined with measured data to improve the spatial and temporal resolution of the data.

Topographic information is mainly obtained by digital elevation model (DEM), unmanned aerial vehicle mapping, and ground RTK measurement. Basic topographic factors such as altitude, slope, and slope direction are extracted from global DEM data, such as SRTM and ASTER GDEM. In addition, for the key study area, the unmanned aerial vehicle LiDAR scanning is used to provide high-precision microtopographic information, which is combined with RTK (real-time kinematic) and CORS (continuous operating reference station) technologies for precise measurement, so as to analyze the influence of the local terrain on the ground surface temperature.

(2) During the data pre-processing stage, a series of data cleaning and standardization measures are adopted in the example to improve the data quality and consistency. First, missing data is filled in by removing outliers and the interpolation method to reduce data noise. Then, for data of different time scales (for example, ground surface monitoring data is at the hourly level, and satellite remote sensing data is usually at the daily level), time series alignment is performed to ensure data consistency. In the spatial dimension, the point data and grid data are unified by the resampling method to make them consistent with the regular grid-type observation data, so as to ensure the validity of subsequent model training.

(3) During the feature extraction and dimension reduction stage, in order to improve the generalization ability of the model, the example adopts principal components analysis (PCA) to reduce the dimension of high-dimensional environmental variables (such as multiple meteorological, soil, and vegetation index), and extracts key factors mainly affecting the changes in ground surface temperature. Meanwhile, new characteristic variables, such as the interaction term between vegetation index and air temperature, and the combination factor of slope and soil moisture, are constructed to enhance the predictive ability of the model. In addition, the correlation analysis and shapley additive explanations (SHAP) method are used to assess the contribution of each feature to the ground surface temperature prediction, and the most representative variables are selected, so as to reduce redundant information and improve computational efficiency.

(4) During the model training stage, extreme gradient boosting decision tree (XGBoost) is taken as the core temperature prediction model in the example. It should be understood that XGBoost is selected because this model can effectively handle the high-dimensional data and improve prediction accuracy by using the nonlinear relationship, and it has the ability to automatically handle missing values and reduce the risk of overfitting by regularization. During the training process, it first divides the dataset into 75% training set and 25% test set to ensure the generalization ability of the model. Subsequently, the model hyperparameters are initialized, including the maximum depth of the tree, the learning rate, and the sampling rate, etc., and the error minimization optimization is performed on the training data.

The sensor array deployed above can be used not only to collect data for training the model, but also to continue to collect the measured temperature information for correcting predicted temperature information at other positions in the target permafrost region after the model training is completed. Therefore, the server can also obtain the measured temperature information of the target permafrost region by the multi-stage temperature sensor array deployed in the target permafrost region, where the lower-stage array in the multi-stage temperature sensor array is distributed in grid of the upper-stage array, and the lower-stage array and the upper-stage array include the same number of temperature sensors and have the same distribution pattern.

Based on the description of step S1 in the above embodiment, the step S2 in FIG. 1 is continued to be described below.

S2, correcting the predicted temperature information by a pre-constructed semi-variational function model to obtain optimized predicted temperature information.

The semi-variational function model characterizes a measurement error of the ground surface temperature, spatial variability, and a distance of spatial autocorrelation in the target permafrost region. The first thing to be understood here is that the semi-variational function model is a tool in geostatistics and used to characterize the autocorrelation of spatial data, that is, how the similarity degree between data values changes with increasing of spatial distance. The model draws a semi-variational function curve by calculating the semi-variance between data points with different spacing, and fits the semi-variational function curve by using a mathematical model (such as an exponential model, a Gaussian model, or a spherical model). The semi-variational function model is widely used in spatial interpolation (such as kriging interpolation) and error correction. It can be used to optimize the prediction results of environmental variables (such as temperature, humidity, and soil moisture), thereby improving the spatial consistency and accuracy of the data.

Therefore, before the step S2 shown in FIG. 1, the server further performs a spatial variability analysis based on the measured temperature information to obtain the semi-variational function curve, and fits the semi-variational function model according to the semi-variational function curve.

In implementation details, the server can first perform the data normality and trend effect analysis on the measured temperature information, so as to assess the distributional characteristic of the acquired measured temperature information and its overall trend in space. The data normality analysis is adopted since that when spatial statistical modeling (such as kriging interpolation) is performed, many geostatistical methods require that the data should follow a normal distribution. If the data deviates from the normal distribution, it may affect the accuracy of spatial interpolation. Therefore, it first needs to test whether the measured temperature information conforms to the normal distribution. The trend effect analysis is used to determine whether there is a systematic pattern of change in the ground surface temperature data in the space. For example, whether the ground surface temperature shows an increasing or decreasing trend with changes in latitude, longitude, altitude, or other geographic factors. If there is an obvious trend effect in the data, the direct use of spatial interpolation methods such as kriging interpolation may lead to errors. Therefore, the trend needs to be modeled and removed before interpolation.

Then, spatial variability analysis of the target permafrost region is performed to determine the changing pattern of the ground surface temperature at different spatial scales. Since the ground surface temperature in permafrost region is influenced by multiple environmental factors (such as altitude, soil moisture, and vegetation coverage), it often shows a non-uniform distribution in space. Therefore, the semi-variational function needs to be used as a tool to measure the spatial autocorrelation distance of temperature. The core idea is to calculate a temperature difference between any two observation points, and to reveal the correlation of the temperature at different spatial distances. The semi-variational function is calculated as follows:

$$y ( h ) = \frac{1}{2 N ( h )} {\sum }_{i = 1}^{N ( h )} {[ Z ( {x}_{i} ) - Z ( {x}_{i} + h ) ]}^{2} ,$$

where y(h) represents the semi-variational function; N(h) represents the number of pairs of observation points with a distance of h; and Z(xᵢ), Z(xᵢ+h) represent the ground surface temperature where a position distance is h. Therefore, by calculating the semi-variance values at different distances h, the semi-variational function curve can be obtained, so as to analyze the spatial autocorrelation of the ground surface temperature. In the embodiment, in order to further analyze whether the spatial heterogeneity has a directional nature, the semi-variational function is calculated by setting different angles (0°, 45°, 90°, 135°).

Next, based on the calculated semi-variational function curve, the server needs to select a suitable mathematical model for fitting, such as the exponential model, spherical model, or Gaussian model, so as to construct the semi-variational function model. Therefore, the spatial distribution pattern and correlation of ground surface temperatures at different grid points can be investigated. For example, it is constructed with an exponential model:

$$γ ( h ) = {C}_{0} + C [ 1 - {e}^{- \frac{h}{a}} ] .$$

In the formula, a represents the range, which indicates the maximum distance of spatial autocorrelation; when exceeding this distance, the correlation between temperature data tends to disappear; C represents the structural variance; C₀ is the nugget, which indicates the value of the semi-variational function when the distance is zero and reflects the measurement error or temperature fluctuation on the microscopic scale; and (C+C₀) is the sill, which represents the maximum of the semi-variational function and reflects the overall variation degree of the ground surface temperature. Thus,

$$\frac{C}{( C + {C}_{0} )}$$

represents the degree of spatial correlation of system variables. “<25%, 25-75%, and >75%” indicate weak, moderate, and strong spatial correlation of ground surface temperature respectively. The embodiment performs parameter fitting on the model based on the least squares method, and performs model validation and optimization by using cross-validation and residual analysis. Therefore, the key parameters of the semi-variational function model can be used to assess the variability of the measurement error and measurement value, and at the same time to obtain the maximum distance of the spatial autocorrelation, which provides a basis for setting the distance between observation points sequentially.

Based on the obtained semi-variational function model, the server can correct the predicted temperature information by using the model. In this regard, it should be understood that since the predicted temperature information is usually obtained by machine learning models such as XGBoost based on the prediction of environmental variables (e.g., vegetation, soil, climate, and terrain), there may be certain deviations. Therefore, the predicted temperature information corrected by the semi-variational function model can more accurately reflect the real spatial distribution characteristics of the ground surface temperature.

Based on the description of step S3 in the above embodiment, the steps S3 and S4 in FIG. 1 are continued to be described below.

S3, combining the optimized predicted temperature information with the measured temperature information to obtain ground surface temperature information of the target permafrost region.

In this regard, it can be understood that through the grid measurement, it obtains the ground surface temperature data of a small area of the target permafrost region; in other words, the local and discrete high-precision observation point data is collected by deploying sensors in the regular grid. These data have a high temporal resolution (e.g., collected every half hour). However, the coverage is limited to the area where the sensors are deployed. The predicted ground surface temperature information is large-scale, i.e., the ground surface temperature of the entire permafrost region is estimated based on remote sensing data (such as MODIS and Landsat thermal infrared imagery) and the machine learning model (XGBoost). Therefore, in the embodiment, the optimized predicted temperature information can be matched and integrated with the measured temperature information on the spatial and temporal scales, so as to improve the accuracy and completeness of the ground surface temperature estimation.

S4, generating a ground surface thermal state distribution map of the target permafrost region based on the ground surface temperature information of the target permafrost region.

In the embodiment, the server can perform the spatial interpolation based on the spatial autocorrelation information of the ground surface temperature of target permafrost region and the ground surface temperature information of target permafrost region, so as to obtain the temperature distribution information of the target permafrost region, and generate a ground surface thermal state distribution map of the target permafrost region based on the temperature distribution information.

It can be understood that when the server generates the ground surface thermal state distribution map of the target permafrost region, it first needs to use the spatial autocorrelation analysis method to process the ground surface temperature information of the target permafrost region, so as to determine the spatial correlation and variation trend of the ground surface temperature. Since the core of spatial autocorrelation analysis is to determine the similarity of ground surface temperatures between adjacent regions, i.e., the degree of spatial aggregation or dispersion of temperature data, it can reveal the distribution characteristics of ground surface temperature at different spatial scales, which provides theoretical support for the subsequent interpolation calculation.

After obtaining the spatial autocorrelation information, the next step is to perform interpolation calculations on the ground surface temperature of the target permafrost region based on this information. That is, the temperature data is spatially supplemented and optimized through interpolation methods so as to improve the accuracy of the temperature distribution. During this process, the server can use the kriging interpolation method, which is based on the semi-variational function model and uses the temperature values of known measurement points to assess the temperature values of unknown measurement points. The kriging interpolation can not only take into account spatial autocorrelation, but also finely model the spatial variability of temperature data by range, nugget, and sill, thus obtaining more accurate temperature distribution information.

After completing the interpolation calculation, the temperature distribution information of the target permafrost region is obtained. The server can further use geographic information system (GIS) to perform visual processing of the data, and finally the ground surface thermal state distribution map of the target permafrost region is generated. In the GIS, different spatial mapping methods, such as isotherm drawing, heatmap, or graded color filling can be used to make the spatial distribution characteristics of the ground surface temperature more intuitive. At the same time, through combining environmental factors such as vegetation, soil, topography, and terrain, the relationship between temperature distribution and environmental factors can be further analyzed, thereby providing a scientific basis for ecological environment monitoring, engineering construction, and climate change research in the permafrost region.

Therefore, the method provided by the embodiment can provide high-precision prediction and spatial distribution mapping of the ground surface thermal state in the permafrost region, which improves the accuracy and spatial consistency of the temperature estimation. Moreover, the integrity and reliability of temperature monitoring are enhanced by multi-scale data combination, and the damage to the ecological environment caused by traditional temperature measurement methods is reduced.

Based on the same inventive concept as the ground surface thermal state distribution estimation method for regular grid-type permafrost region provided by the embodiment, the embodiment further provides a ground surface thermal state distribution estimation device of regular grid-type permafrost region, wherein the device includes at least one software function module that can be stored in a memory in the form of software or solidified in an electronic device. The processor in the electronic device is configured to execute executable modules stored in the memory, such as software function modules and computer programs included in the device. Referring to FIG. 4, functionally divided, the device can include:
a temperature acquisition module 11, configured to obtain measured temperature information and predicted temperature information of a target permafrost region, wherein the measured temperature information includes measured ground surface temperatures at multiple observation scales, and the predicted temperature information includes predicted ground surface temperatures at multiple observation scales;
a temperature optimization module 12, configured to correct the predicted temperature information by a pre-constructed semi-variational function model to obtain optimized predicted temperature information, wherein the semi-variational function model characterizes a measurement error of the ground surface temperature, a spatial variability, and a maximum distance of a spatial autocorrelation in the target permafrost region, and
the temperature optimization module 12 is further configured to combine the optimized predicted temperature information with the measured temperature information to obtain ground surface temperature information of the target permafrost region; and
a map drawing module 13, configured to generate a ground surface thermal state distribution map of the target permafrost region based on the ground surface temperature information of the target permafrost region.

In the embodiment, the temperature acquisition module 11 is configured to implement step S1 in FIG. 1; the temperature optimization module 12 is configured to implement steps S2 and S3 in FIG. 1; and the map drawing module 13 is configured to implement step S4 in FIG. 1. Therefore, the detailed description of each above module can be found in the specific embodiments of corresponding steps.

In addition, since the same inventive concept as the ground surface thermal state distribution estimation method for regular grid-type permafrost region provided in the embodiment, the ground surface thermal state distribution estimation device of regular grid-type permafrost region can further realize other steps or sub-steps of the method by the above modules.

Optionally, the temperature acquisition module 11 is further specifically configured to:
obtain the measured temperature information of the target permafrost region by the multi-stage temperature sensor array deployed in the target permafrost region, wherein the lower-stage array in the multi-stage temperature sensor array is distributed in grid of the upper-stage array, and the lower-stage array and the upper-stage array include the same number of temperature sensors and have the same distribution pattern.

Optionally, the temperature acquisition module 11 is further specifically configured to:
obtain the vegetation information, soil information, climate information, and topographic information of the target permafrost region; and
processing the vegetation information, soil information, climate information, and topographic information by a pre-trained temperature prediction model, so as to obtain predicted temperature information of the target permafrost region.

Optionally, before the step of correcting the predicted temperature information by a pre-constructed semi-variational function model, the temperature optimization module 12 is further configured to:
perform a spatial variability analysis based on the measured temperature information to obtain the semi-variational function curve, and
fit the semi-variational function model according to the semi-variational function curve.

Optionally, the map drawing module 13 is further specifically configured to:
perform the spatial interpolation based on the spatial autocorrelation information of the ground surface temperature of target permafrost region and the ground surface temperature information of target permafrost region, so as to obtain the temperature distribution information of the target permafrost region, and
generate a ground surface thermal state distribution map of the target permafrost region based on the temperature distribution information.

Additionally, in the embodiments of the present disclosure, the respective functional modules can be integrated together to form an independent part, can exist separately, or two or more modules can be integrated to form an independent part.

It also should be understood that if the above embodiments are realized in the form of a software functional module and sold or used as an individual product, the function can be stored in a computer readable storage medium. Based on this understanding, the technical solution of the present disclosure in essential, the part contributing to the prior art, or the part of the technical solutions can be embodied in the form of the software product. The computer software product is stored in a storage medium, including several instructions to cause a computer device (which may be a personal computer, a server, or a network device, etc.) to perform all or part of the steps of the method described in each embodiment of the present disclosure.

Therefore, the embodiment of the present disclosure further provides a storage medium, and the storage medium stores a computer program, wherein when the computer program is executed by the processor, the ground surface thermal state distribution estimation method for regular grid-type permafrost region is realized by the embodiment. The storage medium can be U disk, portable hard disk, ROM (read only-memory), RAM (random access memory), disk, disc, or other medium that can store the program code.

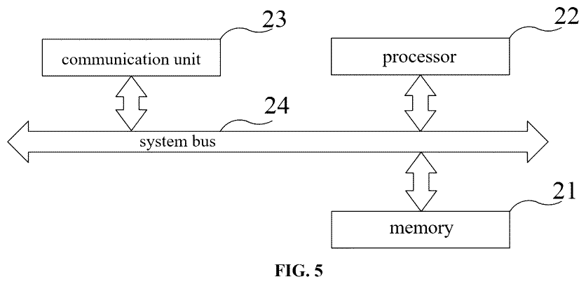

The embodiment provides an electronic device for implementing the ground surface thermal state distribution estimation method for regular grid-type permafrost region. As shown in FIG. 5, the electronic device can include a processor 22 and a memory 21. Furthermore, the memory 21 stores a computer program, and the processor realizes the ground surface thermal state distribution estimation method for regular grid-type permafrost region provided by the embodiment through reading and executing the computer program in the memory 21 corresponding to the above embodiment.

Continuing to refer to FIG. 5, the electronic device further includes a communication unit 23. The components of the memory 21, the processor 22, and the communication unit 23 are electrically connected to each other directly or indirectly via the system bus 24, so as to realize the transmission or interaction of data.

The memory 21 can be an information recording device based on any electronic, magnetic, optical, or other physical principle for recording executable instructions, and data, etc. In some embodiments, the memory 21 can be, but is not limited to, volatile memory, non-volatile memory, storage drive, etc.

In some embodiments, the volatile memory can be Random Access Memory (RAM). In some embodiments, the non-volatile memory can be Read Only Memory (ROM), Programmable Read-Only Memory (PROM), Erasable Programmable Read-Only Memory (EPROM), Electric Erasable Programmable Read-Only Memory (EEPROM), or flash memory, etc. In some embodiments, the storage drive can be a disk drive, a solid-state drive, any type of storage disk (such as CD and DVD), similar storage media, or a combination of them.

The communication unit 23 is configured to send and receive data by the network. In some embodiments, the network can include a wired network, a wireless network, a fiber optic network, a remote communication network, an intranet, the Internet, a Local Area Network (LAN), a Wide Area Network (WAN), a Wireless Local Area Network (WLAN), a Metropolitan Area Network (MAN), a Wide Area Network (WAN), a Public Switched Telephone Network (PSTN), a Bluetooth network, a ZigBee network, or a Near Field Communication (NFC) network, or any combination thereof. In some embodiments, the network can include one or more network access points. For example, the network can include wired or wireless network access points, such as base station and/or network switching node. One or more components of the service request processing system can be connected to the network by the access point to exchange data and/or information.

The processor 22 can be an integrated circuit chip with signal processing capability, and the processor can include one or more processing cores (such as single-core processor or multi-core processor). For illustrative purposes only, the above processor can include Central Processing Unit (CPU), Application Specific Integrated Circuit (ASIC), Application Specific Instruction-set Processor (ASIP), Graphics Processing Unit (GPU), Physics Processing Unit (PPU), Digital Signal Processor (DSP), Field-Programmable Gate Array (FPGA), Programmable Logic Device (PLD), controller, microcontroller unit, Reduced Instruction Set Computing (RISC), microprocessor, or any combination thereof.

It can be understood that the structure shown in FIG. 5 is illustrative only. The electronic device 100 can further have more or fewer components than shown in FIG. 5, or have a different configuration than shown in FIG. 5. The components shown in FIG. 5 can be implemented in hardware, software, or a combination thereof.

It should be understood that the disclosed device and method in the above embodiments can also be realized in other ways. The embodiments of the device described above are only illustrative, for example, the flow schematic diagrams and block schematic diagrams in the drawings show the architecture, functionality, and operation that may be realized by the device, method, and computer program product according to the plurality of embodiments of the present disclosure. At this point, each box in the flow schematic diagram or block schematic diagram may represent a module, program segment, or a part of code, and the module, program segment, or a part of the code includes one or more executable instructions for realizing specified logical functions. It should also be noted that in some embodiments as the replacement, the functions indicated in the boxes may also occur in a different order than those indicated in the drawings. For example, two consecutive blocks can actually be executed essentially in parallel, and they can sometimes be executed in reverse order, which depends on the functions involved. It is also noted that each block in the block diagram and/or flow diagram and a combination of blocks in the block diagram and/or flow diagram may be realized by a dedicated hardware-based system that executes the specified function or action, or may be realized by a combination of the dedicated hardware and computer instructions.

The foregoing description is merely various embodiments of the present disclosure, but the scope of protection of the present disclosure is not limited thereto. Any person skilled in the art can easily conceive of modifications or substitutions within the scope of the technology disclosed in the present disclosure, which shall fall within the scope of protection of the present disclosure. Therefore, the scope of protection of the present disclosure shall be subject to the scope defined by the claims.

1. An estimation method for ground surface thermal state distribution at regular grid in permafrost region, wherein the method comprises:
obtaining measured temperature information and predicted temperature information of a target permafrost region, wherein the measured temperature information comprises measured ground surface temperatures at multiple observation scales; the predicted temperature information comprises predicted ground surface temperatures at multiple observation scales; and the multiple observation scales show a pattern of progressive transition, wherein the step comprises:
obtaining the measured temperature information of the target permafrost region by a multi-stage temperature sensor array deployed in the target permafrost region, wherein a lower-stage array in the multi-stage temperature sensor array is distributed in a grid of an upper-stage array, and the lower-stage array and the upper-stage array comprise the same number of temperature sensors and have the same distribution pattern;
obtaining vegetation information, soil information, climate information, and topographic information of the target permafrost region; and
processing the vegetation information, soil information, climate information, and topographic information by a pre-trained temperature prediction model, so as to obtain predicted temperature information of the target permafrost region;
correcting the predicted temperature information by a pre-constructed semi-variational function model to obtain optimized predicted temperature information, wherein the semi-variational function model characterizes a measurement error of the ground surface temperatures, spatial variability, and a maximum distance of spatial autocorrelation in the target permafrost region;
combining the optimized predicted temperature information with the measured temperature information to obtain ground surface temperature information of the target permafrost region; and
generating a ground surface thermal state distribution map of the target permafrost region based on the ground surface temperature information of the target permafrost region.

2. The estimation method for ground surface thermal state distribution at regular grid in permafrost region according to claim 1, wherein the temperature prediction model is obtained by training XGBoost model with sample data.

3. The estimation method for ground surface thermal state distribution at regular grid in permafrost region according to claim 1, wherein before a step of correcting the predicted temperature information by a pre-constructed semi-variational function model to obtain optimized predicted temperature information, the method further comprises:
performing a spatial variability analysis based on the measured temperature information to obtain the semi-variational function curve, and
fitting the semi-variational function model based on the semi-variational function curve.

4. The estimation method for ground surface thermal state distribution at regular grid in permafrost region according to claim 1, wherein a step of generating a ground surface thermal state distribution map of the target permafrost region based on the ground surface temperature information of the target permafrost region comprises:
performing a spatial interpolation based on spatial autocorrelation information of the ground surface temperatures of the target permafrost region and the ground surface temperature information of the target permafrost region, so as to obtain temperature distribution information of the target permafrost region, and
generating the ground surface thermal state distribution map of the target permafrost region based on the temperature distribution information.

5. An estimation apparatus for ground surface thermal state distribution at regular grid in permafrost region, wherein the device comprises:
a temperature acquisition module, configured to obtain measured temperature information and predicted temperature information of a target permafrost region, wherein the measured temperature information comprises measured ground surface temperatures at multiple observation scales; the predicted temperature information comprises predicted ground surface temperatures at multiple observation scales; and the multiple observation scales show a pattern of progressive transition, wherein the temperature acquisition module is further configured to:
obtain the measured temperature information of the target permafrost region by a multi-stage temperature sensor array deployed in the target permafrost region, wherein the lower-stage array in the multi-stage temperature sensor array is distributed in a grid of the upper-stage array, and the lower-stage array and the upper-stage array comprise the same number of temperature sensors and have the same distribution pattern;
obtain vegetation information, soil information, climate information, and topographic information of the target permafrost region; and
process the vegetation information, soil information, climate information, and topographic information by a pre-trained temperature prediction model, so as to obtain predicted temperature information of the target permafrost region;
a temperature optimization module, configured to correct the predicted temperature information by a pre-constructed semi-variational function model to obtain optimized predicted temperature information, wherein the semi-variational function model characterizes a measurement error of the ground surface temperatures, a spatial variability, and a maximum distance of a spatial autocorrelation in the target permafrost region, and
further configured to combine the optimized predicted temperature information with the measured temperature information to obtain ground surface temperature information of the target permafrost region; and
a map drawing module, configured to generate a ground surface thermal state distribution map of the target permafrost region based on the ground surface temperature information of the target permafrost region.

6. A storage medium, wherein the storage medium stores a computer program, and the estimation method for ground surface thermal state distribution at regular grid in permafrost region according to claim 1 is realized when the computer program is executed by a processor.

7. An electronic device, wherein the electronic device comprises a processor and a memory; the memory stores a computer program; and the estimation method for ground surface thermal state distribution at regular grid in permafrost region according to claim 1 is realized when the computer program is executed by the processor.
